(19) United States
(12) Patent Application Publication
(10) Pub. No.: US 2003/0089956 A1
(43) Pub. Date: May 15, 2003

(54) Polarization rotators, articles containing the polarization rotators, and methods of making and using the same

(76) Inventors: Richard Charles Allen, Lilydale, MN (US); Christopher C. Bowley, Somerville, MA (US); Stephan John Pankratz, Minneapolis, MN (US); Philip Edwin Watson, Oakdale, MN (US)

Correspondence Address: 3M INNOVATIVE PROPERTIES COMPANY, PO BOX 33427, ST. PAUL, MN, 55133-3427, US

(21) Appl. No.: 09/966,557

(22) Filed: Sep. 27, 2001

(51) Int. Cl. G03G 15/36

(52) U.S. Cl. 257/432

(57) ABSTRACT

Polarization rotators contain (i) a polarizer element or other polarization rotating element and (ii) a separate polarization rotator element. Articles containing the polarization rotators can be formed.

### FIELD OF THE INVENTION

This invention relates to polarization rotators, articles containing the polarization rotators, and methods of using and making the same. In addition, the invention relates to articles that include a polarization rotator element and another polarization-altering element, such as a polarizer element, and methods of using and making the same.

### BACKGROUND OF THE INVENTION

Optical films have been developed for a variety of applications including, for example, eyewear, building and vehicle window treatments, and displays. In many of these applications, there is a desire to obtain and manipulate polarized light. For example, polarized light can be used to reduce glare.

A liquid crystal display (LCD) illustrates another example of the use of polarized light. FIGS. 1A and 1B schematically illustrate one example of a simple TN (twisted nematic) LCD device with E-mode transmission and normally white (NW) operation using a backlight. It will be understood that there are a variety of other LCD types and other modes of operation, as well as displays that use ambient light or a combination of a backlight and ambient light. The inventions discussed herein can be readily applied to these display types and modes of operation.

The LCD 50 of FIGS. 1A and 1B includes a liquid crystal (LC) cell 52, a polarizer 54, an analyzer 56, and a backlight 58. The arrows 55, 57 on the polarizer 54 and analyzer 56, respectively, indicate the polarization of light that is transmitted through that component. Arrows 51, 53 indicate the plane of polarization of linearly of the LC cell 52 containing arrows 51, 53 generally includes transparent electrodes. Light from the backlight 58 is linearly polarized by the polarizer 54. In the embodiment illustrated in FIG. 1A, in the absence of an electric potential applied across the LC cell, the director substantially lies in the plane of the display twisting uniformly through 90° along its depth. The polarized light is transmitted through the LC cell 52 where the polarization ideally rotates by 90°, with the director of the liquid crystals indicated by the arrows 51, 53. This light can then be transmitted through the analyzer 56.

An electric potential can be applied at electrodes (not shown) proximate to opposing ends of the LC cell 52, setting up an electric field within the LC cell. In the case where the LC material has a positive dielectric anisotropy, the director substantially aligns in the direction of the electric field lines, provided sufficient potential is applied across the electrodes. The director at the center of the cell is oriented perpendicular to the plane of the display in this case. The linearly polarized light entering the cell is no longer rotated through the 90° required for transmission through the analyzer. In the embodiment illustrated in FIG. 1B, the plane of polarization of the polarized light as it exits LC cell 52 (designated by arrow 53′) is unchanged from its original orientation (designated by arrow 51). Hence, the light exiting the LC cell 52 is not transmitted through the analyzer 56, because the light exiting the LC cell has the wrong polarization. One method of obtaining a gray scale includes only applying sufficient electric potential to partially orient the director of the liquid crystals between the two illustrated configurations. In addition, it will be recognized that a color cell can be formed by, for example, using color filters.

Typically, the polarizer 54 and analyzer 56 are constructed using absorbing sheet polarizers because these polarizers have good extinction of light having the unwanted polarization. This, however, results in substantial loss of light because the backlight generally emits unpolarized light. Light of the unwanted polarization is absorbed by the polarizer. As an alternative configuration (illustrated in FIG. 1C), a reflective polarizer 60 is placed between the polarizer 54 and the backlight 58. The reflective polarizer reflects light with the unwanted polarization back towards the backlight. The reflected light can be recycled using a reflector 62 behind the backlight where a substantial portion of the reflected light can be reused.

One method of producing a reflective polarizer uses alternating layers of polymer materials, where at least one of those layers is birefringent as described, for example, in U.S. Pat. Nos. 5,882,774 and 5,965,247, both of which are incorporated herein by reference. These polarizers can be manufactured by stretching the polymer materials to induce birefringence and orient the polymer.

A second method of producing reflective polarizers includes one or more layers containing continuous and disperse phases of polymer materials, where at least one of those polymer materials is birefringent as described, for example, in U.S. Pat. Nos. 5,783,120 and 5,825,543, both of which are incorporated herein by reference.

Both of these two methods of making a reflective polarizer typically stretch or orient the reflective polarizer on a polymer web in either or both the machine (0°) or transverse (90°) directions. However, many twisted nematic (TN) LCD's have the transmission axes of the polarizer and analyzer at ±45° with respect to the vertical display direction. Thus, the reflective polarizer must be bias cut at a 45° angle with respect to the web to obtain a film with the proper orientation of the polarization axis for use with an LCD. This can result in a substantial loss of material due to the angular cut.

A third method of making a reflective polarizer includes the use of cholesteric liquid crystals and a quarter wave retarder, as taught, for example, in U.S. Pat. Nos. 5,506,704 and 6,099,758, both of which are herein incorporated by reference. The cholesteric reflective polarizer transmits one helicity of circularly polarized light and reflects the other helicity. The quarter wave retarder converts the transmitted circularly polarized light into linearly polarized light. Circular polarizers do not function in the same Cartesian coordinate eigenspace as linear polarizers, and it is the optical axis of the quarter wave retarder that specifies the azimuthal orientation of the plane of polarization of the linearly polarized light. Quarter wave retarders are often made by orienting birefringent films. On passing through a quarter wave retarder, circularly polarized light is converted to linearly polarized light with its polarization axis +45 or −45 degrees away from the optical axis of the quarter wave retarder, with the direction determined by the specific circular polarization state. Quarter wave retarders are often made by orienting films with the optical axis either parallel or perpendicular to the film roll direction. Thus, the output light of such a structure will be at 45° or 135° to the web direction. It is common to include a conventional absorbing sheet polarizer laminated to the cholesteric polarizer structure in order to ensure high contrast by “cleaning up” any light of the unwanted polarization state leaked by the cholesteric assembly. However, in roll-goods form, the pass axis of conventional absorbing polarizers is generally along, or optionally perpendicular to, the web direction. Again, either the cholesteric polarizer structure or the dichroic polarizer must be bias cut at 45° in order to align the two elements.

Each of the general methods for making reflective linear polarizers described above involve stretching or orientation of a polymer web in either the machine (0°) or transverse direction (90°). To obtain a polarization direction of 45°, the polymer web is bias cut at a 45° angle. This results in substantial amounts of scrap material.

### SUMMARY OF THE INVENTION

Generally, the present invention relates to polarization rotators, articles containing the polarization rotators, and methods of using and making the same. In addition, the invention relates to articles that include a polarization rotator element and another polarization-altering element, such as a polarizer element, and methods of using and making the same.

One embodiment is a film having a polarizer element and a separate polarization rotator element. The polarizer element has a polarization axis and preferentially transmits light having a polarization that is parallel to the polarization axis. The separate polarization rotator element is configured and arranged to rotate the polarization of at least a portion of the light that is transmitted by the polarizer element by an angle of at least 5 degrees. Optionally, the film includes one or more alignment layers to align surfaces of the polarization rotator element. The film can also include a substrate, one or more other polarizer elements, and one or more other polarization rotator elements. Other polarization altering elements can be used in conjunction with the film or in place of the polarizer element.

Another embodiment is another film that includes a polarizer element and a polarization rotator element. The polarizer element preferentially transmits a substantial portion of light having a first circular polarization. The polarization rotator element is configured and arranged to rotate the polarization of at least a portion of the light that is transmitted by the polarizer element to convert the polarization of the light from the first circular polarization to a first linear polarization. Optionally, the film includes one or more alignment layers to align surfaces of the polarization rotator element. The film can also include a substrate, one or more other polarizer elements, and one or more other polarization rotator elements.

Yet another embodiment is a display that includes a liquid crystal cell that is configured and arranged to operate using polarized light; a light source; and one of the previously described films disposed between the liquid crystal display cell and the light source.

Another embodiment is a method of polarizing light. The light is directed at a polarizer element of a film. The polarizer element preferentially transmitting light having a first polarization. The polarization of at least a portion of the light transmitted by the polarizer element is rotated by at least five degrees using a separate polarization rotator element of the film. Optionally, the film includes one or more alignment layers to align surfaces of the polarization rotator element. The film can also include a substrate, one or more other polarizer elements, and one or more other polarization rotator elements.

The above summary of the present invention is not intended to describe each disclosed embodiment or every implementation of the present invention. The Figures and the detailed description which follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1A is a schematic perspective view of one embodiment of a TN LCD;

FIG. 1B is a schematic perspective view of the LCD of FIG. 1A in which a potential has been applied across the LC cell of the LCD;

FIG. 1C is a schematic perspective view of a second embodiment of an LCD;

FIG. 2 is a schematic cross-sectional view of one embodiment of a film containing a polarization rotator, according to the invention;

FIG. 3 is a schematic cross-sectional view of a second embodiment of a film containing a polarization rotator, according to the invention;

FIG. 4 is a schematic cross-sectional view of a third embodiment of a film containing a polarization rotator, according to the invention;

FIG. 5 is a schematic cross-sectional view of a fourth embodiment of a film containing a polarization rotator, according to the invention;

FIG. 6 is a schematic cross-sectional view of a fifth embodiment of a film containing a polarization rotator, according to the invention;

FIG. 7 is a schematic cross-sectional view of a sixth embodiment of a film containing a polarization rotator, according to the invention;

FIG. 8 is a schematic cross-sectional view of a seventh embodiment of a film containing a polarization rotator, according to the invention;

FIG. 9 is a schematic cross-sectional view of an eighth embodiment of a film containing a polarization rotator, according to the invention; and

FIG. 10 is a schematic perspective view of one embodiment of an LCD, according to the invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION OF THE PREFERRED EMBODIMENT

The present invention is believed to be applicable to polarization rotators and articles containing the polarization rotators, as well as methods of making and using the polarization rotators and articles. In particular, the present invention is directed to articles, such as films, that include a) a polarizing element or other polarization-altering element and b) a polarization rotator element and methods of making and using such articles. While the present invention is not so limited, an appreciation of various aspects of the invention will be gained through a discussion of the examples provided below.

As an example, a polarization rotator element can be provided with the appropriate amount of optical rotation to substantially match the optical axis of a first optical device to the optical axis of a second optical device. Additionally or alternatively, the polarization rotator element can enable the manufacture of a laminate structure comprising the aforementioned first optical device with first optical axis, the polarization rotator element, and the second optical device with second optical axis in a roll-to-roll or other method. In another example, an article including a first optical device with a first optical axis coupled to a polarization rotator element can be part-cut from a roll with relatively low yield loss.

Articles of the present invention generally include a polarization rotator element and an optical element with an optical axis. The optical element can be, for example, a polarizer, a compensation film, a Brewster-type polarizing device, a polarizing lightguide, or a mirror. Alternatively the optical element can be a lenticular refractive optic such as a turning lens, a brightness enhancement film (as described, for example, in U.S. Pat. No. 5,917,664, incorporated herein by reference), or a cylindrical lens array. For illustrative purposes, much of the discussion herein will focus on the combination of a polarization rotator element and a polarizer or refractive element. It will be understood that the polarizer or refractive element can be replaced by any other optical element or article. The combination of a polarization rotator element and the polarization-altering element into a single film or other article can be advantageous. As an example, a linear sheet polarizer is used in a liquid crystal display (LCD). Many LCD's use at least one absorbing sheet polarizer which is usually attached to the glass substrates of the liquid crystal cell. The orientation of the pass axis of the sheet polarizer with respect to the vertical and horizontal directions of the display are chosen depending upon the liquid crystal electro-optic distortion mode of the display and the desired chromatic and symmetry properties of the image. For twisted nematic (TN) LCD's, this is typically at an angle of about 45° with respect to the vertical axis of the LCD. Placing a 45° optical rotator between the sheet polarizer and the display glass would allow parts to be cut optimally from the web, eliminating the yield loss associated with the angle cut.

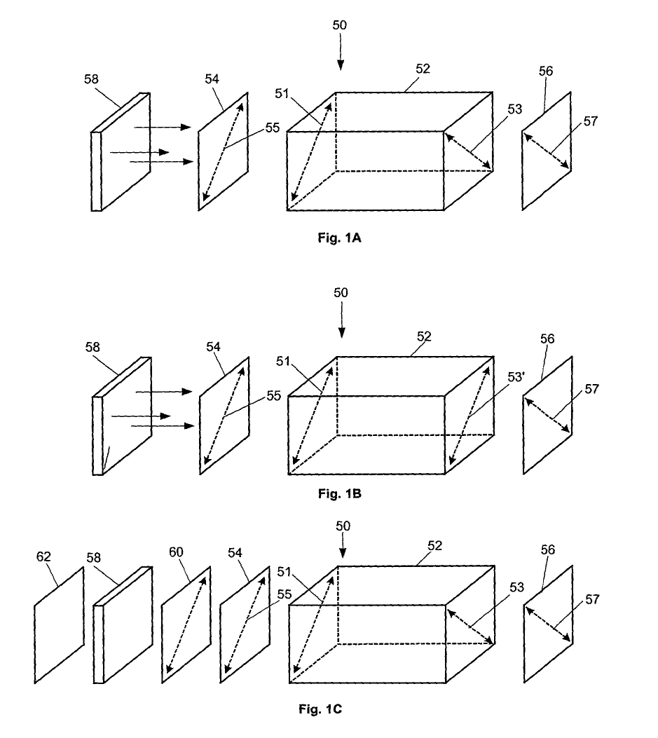

Other examples of linear polarizers used in LCD's include certain types of reflective polarizers. When isotropic light is incident on a reflective polarizer, one polarization of light is substantially transmitted and the other polarization of light is substantially reflected. When placed in the backlight cavity of an LCD the blocked polarization state of light is reflected back towards the backlight for recycling. Reflective polarizers can be used in addition to absorbing polarizers in an LCD, or instead of an absorbing polarizer in some LCD types. In the case where the reflective polarizer is used in addition to an absorbing polarizer, the light transmitted by the reflective polarizer proceeds to an LC cell between two polarizers, as illustrated, for example, in FIG. 1C and discussed above. To be most effective, the light transmitted by the reflective polarizer should have the same plane of polarization as the LCD polarizer transmission axis. Again, for twisted nematic (TN) LCD's, this is typically at an angle of about 45° with respect to the vertical axis of the LCD.

One method of producing a reflective polarizer uses alternating layers of different polymer materials, where at least one of those polymer materials is birefringent as described, for example, in U.S. Pat. Nos. 5,882,774 and 5,965,247, both of which are herein incorporated by reference. These polarizers can be manufactured by stretching the polymer materials to induce birefringence and orient the polymer.

A second method of producing reflective polarizers includes forming continuous and disperse phases of different polymer materials, where at least one of those phases is birefringent as described, for example, in U.S. Pat. Nos. 5,783,120 and 5,825,543, both of which are herein incorporated by reference.

Manufacturing linear sheet polarizer, both absorbing and reflective polarizers, typically includes stretching or orienting the polarizer on a polymer web in either or both the machine (0°) or transverse (90°) directions. This results in a plane of polarization of the transmitted light being oriented either in the machine direction or the transverse direction. However, many TN LCD's have the transmission axes of the polarizer and analyzer at ±45° with respect to the vertical display direction. Thus, the reflective polarizer must be bias cut at a 45° angle with respect to the web to obtain a film with the proper orientation of the polarization axis for use with an LCD. This can result in a substantial loss of material due to the angular cut.

As an alternative, a 45° polarization rotator can be placed between the reflective polarizer and LCD polarizer. As described herein, the advantages of preparing a single film or other article with a reflective polarizer element (or other polarization altering element) and a polarization rotator element can also include a savings in space because of reduced thickness and a pre-aligned orientation between the reflective polarizer element and the polarization rotator element.

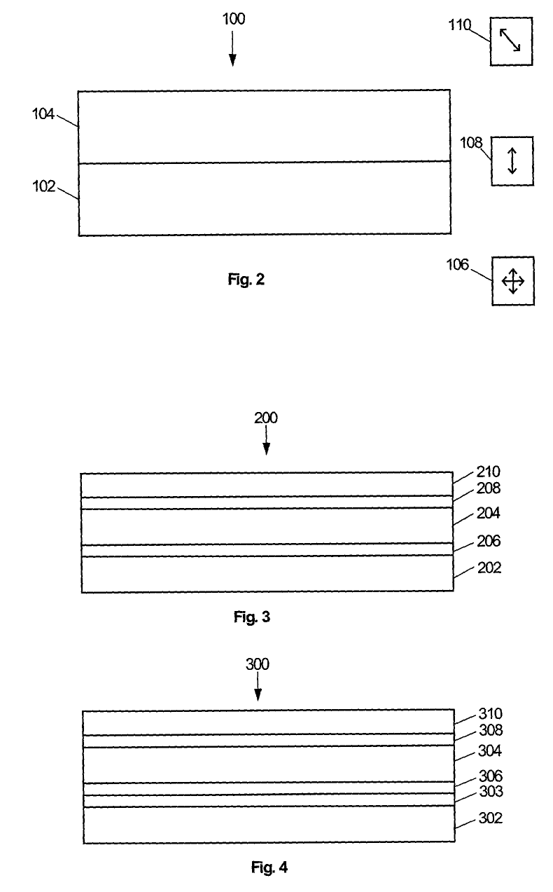

FIG. 2 schematically illustrates one embodiment of a film 100 having a polarizer element 102 and a polarization rotator element 104. Unpolarized light, which can be considered to be composed of equal amounts of linearly polarized light with planes of polarization mutually orthogonal and their electric vectors in the plane of the film (indicated by arrows in box 106), is directed toward the polarizer element 102 which transmits polarized light (as indicated in box 108). The polarization rotator element 104 rotates the polarization (box 110) of the light. In the illustrated case, the rotation is 45°. However, it will be understood that any rotational angle can be chosen. It will be recognized that articles can also be formed where the polarizer element is replaced by another polarization-altering element.

Polarization rotator elements could be used to reduce the yield loss of multifunctional optical films, such as those that combine the function of an absorptive and reflective polarizer. Reduction in yield loss for such films by eliminating angle cutting would be desirable due to the composite nature, and presumably higher value, of the multifunctional film.

Polarization rotator elements can also be advantageous in enabling the manufacture of optical devices using one or more optical films in the form of roll goods. Many optical films of combined functionality are made by the direct lamination of optical films of lesser functionality. Examples of these include elliptically and circularly polarizing films formed by laminating retardation films to absorbing sheet polarizers and films combining reflective polarizers and absorbing polarizers.

A third method of making a reflective polarizer includes the use of cholesteric liquid crystals and a quarter wave retarder, as taught, for example, in U.S. Pat. Nos. 5,506,704 and 6,099,758, both of which are herein incorporated by reference. The cholesteric reflective polarizer transmits one helicity of circularly polarized light and reflects the other helicity. The quarter wave retarder converts the transmitted circularly polarized light into linearly polarized light. Circular polarizers do not function in the same Cartesian coordinate eigenspace as linear polarizers, so it is the optical axis of the quarter wave retarder that specifies the azimuthal orientation of the plane of polarization of the linearly polarized light transmitted by the structure. Quarter wave retarders can be made by orienting birefringent films. On passing through a quarter wave retarder, circularly polarized light is converted to linearly polarized light with its polarization axis +45 or −45 degrees away from the optical axis of the quarter wave retarder, with the direction determined by the specific circular polarization state. Quarter wave retarder are often made by orienting films with the optical axis either parallel or perpendicular to the film roll direction. Thus, the output light of such a structure will be at 45° or 135° to the web direction. It is common to include a conventional absorbing polarizer laminated to the cholesteric polarizer structure in order to ensure high contrast by “cleaning up” any light of the unwanted polarization state leaked by the cholesteric assembly. However, in roll-goods form, the pass axis of conventional absorbing polarizers is generally along, or optionally perpendicular to, the web direction. Again, either the cholesteric polarizer structure or the absorbing polarizer must be bias cut at 45° in order to align the two elements. Thus, to produce a laminate structure having a cholesteric reflective polarizer, a quarter wave retarder, and a conventional absorbing polarizer using a continuous or roll-to-roll process or both, it is desirable to place a polarization rotator between the quarter wave retarder and the absorbing polarizer. Additionally, it can be further desirable to use a secondary polarization rotating layer on the side of the absorbing polarizer nearest the LC cell in order to reduce material losses resulting from the angular cut.

A variety of materials can be used to form polarization rotator elements including, for example, both organic and inorganic birefringent materials, and multilayer constructions of birefringent materials. The polarization rotator element can be formed using liquid crystal materials, such as nematic and chiral nematic liquid crystal materials, typically with the assistance of one or more alignment layers. FIG. 3 illustrates one embodiment of an article 200 that includes a polarizer element 202 (or other polarization-altering element), a polarization rotator element 204, optional alignment layers 206, 208, and a substrate 210 (which can optionally be an optical element such as a polarizer or compensation film). In other embodiments, as described below, the alignment layers can be part of the polarizer element or substrate.

A polarization rotator generally rotates the principle axes of the polarization ellipse that characterizes polarized light through a selected angle, ideally without substantially changing the ellipticity of the polarized light. Polarization rotators typically rotate the polarization of light by at least 5°, 10°, 25° or more. It is expected that several useful ranges for rotation angles of the polarization rotators are from 40° to 50° (e.g., about 45°) and from 85° to 95° (e.g., about 90°). The angle of rotation is typically a function of parameters such as, for example, the indices of refraction of the polarization rotator element, the thickness of the polarization rotator element, the material(s) used to form the polarization rotator element, the wavelength of light, and the orientation of the optical axes of the birefringent layer(s) of the polarization rotator with respect to the azimuthal angle of the input polarization ellipse.

The polarization rotator element is typically formed using a birefringent material. Examples of suitable birefringent materials include oriented polymer films, laminated structures of oriented polymer films, and both organic and inorganic multilayer birefringent coatings. Other examples include any liquid crystal material that has a director that can be controlled. A nematic liquid crystal is generally composed of rodlike molecules with their long axes aligned approximately parallel to one another. At any point in the medium one can define a vector to represent the preferred orientation in the immediate neighborhood of the point. This vector is commonly called the director. Suitable liquid crystal (LC) materials include, for example, lyotropic, nematic, and cholesteric liquid crystal materials. Examples include E7, BL036, 5CB, and RM257 from Merck; C6M, 76, 296, 495, and 716, from Koninklijke Philips Electronics N.V. (Amsterdam, the Netherlands); Paliocolor LC242 and Paliocolor CM649 from BASF AG (Ludwigshafen, Germany); and LCP-CB483 from Vantico AG (Luxembourg). Additional examples of suitable materials include those described in U.S. Pat. Nos. 5,793,455, 5,978,055, and 5,206,752, all of which are incorporated herein by reference. The LC materials can be polymeric or monomeric materials. Suitable monomeric materials also include those materials that can be reacted to form polymeric liquid crystal materials.

For some embodiments, a twisted nematic LC structure is preferred. In these embodiments, the director exhibits a uniform helical twist about the normal to the surface of the polarization rotator. The twist angle and initial orientation can be selected by the use of one or more optional alignment layers.

In another embodiment, the axis about which the local director of a LC structure twists or rotates is not normal to the surface of the substrate upon which the LC material is disposed. In this embodiment, the nematic director lies out of the plane of the polarizer element or polarization-altering element. With respect to the surface of the substrate, the angle of the axis, at which the local director lies or about which the local director twists, is defined as the pretilt angle, α. The pitch can be constant or can vary (e.g., increase or decrease) along the axis. The twist angle and orientation can be selected by the use of one or more optional alignment layers.

At least some liquid crystal materials, such as chiral nematic (e.g., cholesteric) liquid crystals, include a chiral component which results in the formation of a structure where the director of the liquid crystal material naturally rotates about an axis perpendicular to the director. The pitch of the chiral nematic liquid crystal corresponds to the thickness of material needed to achieve a 360° rotation of the director. At least some achiral nematic liquid crystals can be made chiral by the addition of a chiral compound. The pitch of the material can be modified by changing the ratio of chiral to achiral components.

A uniaxial birefringent material, such as a nematic liquid crystal, is characterized by two principal refractive indices, nₒ and nₑ. The ordinary refractive index, nₒ, influences that component of light whose electric field polarization vector is perpendicular to the optical symmetry axis of the birefringent medium. The extraordinary index, nₑ, influences that component of light whose electric field polarization vector is parallel to the optical symmetry axis of the birefringent medium (for example, parallel to the director in the case of a nematic LC material with positive dielectric anisotropy).

The birefringence, Δn, of the medium can be defined in terms of nₒ and nₑ:

Δn=nₑ−nₒ.

Polarized light incident on a birefringent medium will propagate as an ordinary ray component and an extraordinary ray component. The phase velocity of each component will differ, as each experiences a different index of refraction. The total change in phase, or retardation, of the light depends upon the birefringence and the thickness of the medium.

One embodiment of a suitable polarization rotator element corresponds to a layer having the thickness of a half wave retarder and an optical axis that is set off from the plane of polarization of incident linearly polarized light by an azimuthal angle, φ. The optical axis of the polarization rotator element is in a plane parallel to the “extraordinary” ray and perpendicular to the “ordinary” ray. The half wave retarder rotates the polarization of the incident linearly polarized light by 2φ. For example, a 45° polarization rotator element has an optical axis that is set off from the polarization direction of incident linearly polarized light by 22.5°. The term “half wave retarder” signifies that the polarization rotator element has a thickness, d, with Δnd=(2m+1)λ/2, where λ is the wavelength of light, and m is an integer, 0, 1, 2, . . . . For other wavelengths of light, the polarization rotator may provide different rotational values. This embodiment functions as a perfect rotator only for wavelengths that satisfy the aforementioned requirement.

As yet another example, a polarization rotator element can be a formed using a liquid crystal material whose director rotates along the thickness axis of the polarization rotator element by a twist angle, Φ, which is much smaller than a phase retardation, Γ, of the polarization rotator element. The phase retardation is given by:

Γ=2πΔnd/λ.

When Φ<<Γ for a particular wavelength or wavelength range of light, linearly polarized light incident at one side of the polarization rotator element will emerge rotated by the same amount as the twist angle, Φ, for that wavelength of light. This effect can be achieved when the polarization rotator element includes liquid crystal material having a twisted nematic structure. A twisted nematic structure can be achieved using chiral nematic liquid crystal material or using optional alignment layers on opposing sides of the polarization rotator element (as illustrated, for example, in FIG. 3) where the alignment between the two layers differs by the desired twist angle, or a combination of these methods.

Polarization rotator elements can also be designed to utilize both the twist angle and retardation to alter the polarization and ellipticity of incident light. As an example, consider an input beam of linearly polarized light with its electric field vector parallel to the director of a twisted nematic structure. According to the Jones matrix methods (see, for example, “Optics of Liquid Crystal Displays”, by Pochi Yeh and Claire Gu, John Wiley and Sons, 1999), the output light has ellipticity and azimuth orientation given by:

$$e = tan ( \frac{1}{2} {sin}^{- 1} [ \frac{Γφ}{{X}^{2}} {sin}^{2} X ] )$$

$$tan 2 ψ = \frac{2 φ X tan X}{( {φ}^{2} - \frac{{Γ}^{2}}{4} ) {tan}^{2} X - {X}^{2}}$$

where ψ is the angle of the major axis of the polarization ellipse measured from the local director axis at the exit plane. Here, ø is the twist angle of the TN structure, Γ is the phase retardation as defined above, and:

$$X = \sqrt{{φ}^{2} + {( \frac{Γ}{2} )}^{2}} .$$

For example, for 550 nm light, a polarization rotator element having a birefringence of 0.12, a thickness of 1.62 μm, and a twist angle of 64° can alter the polarization of linearly polarized light to light with ellipticity of −1.

The polarization rotator element can be formed using one or more different layers (e.g., coatings) of material. For example, multiple layers of material can be deposited on a particular substrate or polarizer element with optional solvent removal steps and, optionally, partial or full curing between deposition of the layers. This can be particularly usefull if the particular substrate or polarizer element is sensitive to temperature, humidity, or both. Multiple applications of material can reduce the temperature or time needed to drive away the solvent or cure the material. As another example, layers of material for the polarization rotator element can be formed on different substrates or polarizer elements and then the two layers brought together. This provides a method for combining (e.g., laminating) individual components into a single article. Optionally, an annealing step at elevated temperature can be performed to facilitate diffusion, coupling, or alignment between two or more layers of polarization rotator material.

A liquid crystal material can be selected which includes reactive functional groups that can be used to crosslink the material. Alternatively, a crosslinking or vitrifying agent can be included with the liquid crystal material in the composition used to form the polarization rotator element. The liquid crystal material can be aligned as desired (for example, in a nematic, twisted nematic, or chiral nematic phase) and then crosslinked or otherwise vitrified to retain the alignment. Such crosslinking can be performed by a variety of processes including, for example, by photoinitiated, electron-beam, or thermal curing.

Other materials can be included in the polarization rotator element or the composition used to form the polarization rotator element. For example, a diffusing or scattering material can be included to cause the diffusion or scattering of light, if desired, by the polarization rotator element. As another example, an absorbing material can be included to absorb light of a particular wavelength if, for example, a colored appearance or the removal of a colored appearance is desired. Examples of suitable absorbing materials include, for example, dyes and pigments. In some embodiments, a dichroic dye material (e.g., a material that preferentially absorbs light of one polarization) is used. In particular, a dichroic dye material can be desirable if the dichroic dye material is capable of being aligned within the polarization rotator element. Suitable dichroic dye materials include, for example, iodine, as well as anthraquinone, azo, diazo, triazo, tetraazo, pentaazo, and mericyanine dyes, Congo Red (sodium diphenyl-bis-α-naphthylamine sulfonate), methylene blue, stilbene dye (Color Index (CI)=620), 1,1′-diethyl-2,2′-cyanine chloride (CI=374 (orange) or CI=518 (blue)), 2-phenylazothiazole, 2-phenylazobenzthiazole, 4,4′-bis(arylazo)stilbenes, perylene compounds, 4-8-dihydroxyanthraquinones optionally with 2-phenyl or 2-methoxyphenyl substituents, 4,8-diamino-1,5-naphthaquinone dyes, and polyester dyes such as Palanil™ blue BGS and BG (BASF AG, Ludwigshafen, Germany). The properties of these dyes, and methods of making them, are described in E. H. Land, Colloid Chemistry (1946), incorporated herein by reference. Still other dichroic dyes, and methods of making them, are discussed in the Kirk Othmer Encyclopedia of Chemical Technology, Vol. 8, pp. 652-661 (4th Ed. 1993), and in the references cited therein, all of which are incorporated herein by reference.

Other additives include, for example, oils, plasticizers, antioxidants, antiozonants, UV stabilizers, curing agents, and crosslinking agents. These additives can be reactive with the liquid crystal material or non-reactive.

In one embodiment, a polarization rotator/polarizer element is formed using a twisted nematic structure of a liquid crystal material that also includes absorbing molecules that are oriented with the liquid crystal material. In one example, the absorbing molecules align with the direction of the liquid crystal material. Light having a polarization parallel to the director of the liquid crystal material is absorbed and light having a polarization perpendicular to the liquid crystal material is transmitted. This embodiment of a polarization rotator element also acts as a polarizer. This particular polarization rotator element can be, for example, a “clean-up” polarizer positioned after a reflective polarizer element to enhance the extinction of light of the unwanted polarization state.

The optical properties, including indices of refraction, of any material used in the polarization rotator element can be wavelength dependent. For example, a thickness corresponding to a half wave retarder for one wavelength may generate less than a half wave retardation for a second wavelength. In at least some embodiments, particularly display applications, it is desirable to reduce or minimize variation over a wavelength range, for example, over the visible spectrum of light (e.g., wavelengths from about 380 to about 800 nm). One method of reducing the wavelength dependence (i.e., decreasing the chromaticity) of the polarization rotator element includes the formation of two or more separate layers using different materials and aligning the two layers so that the optical axes of the layers are crossed at a particular angle. For example, the optical axes of the layers can be crossed at 90° to each other. The materials are selected to obtain a polarization rotator element in which Δnd/λ is substantially constant (e.g., varying by no more than 10% or 5%) for a desired wavelength range. For example, a layer of polypropylene can be laid crosswise over a layer of polycarbonate (or vice versa) to obtain an element with substantially uniform optical retardation over the entire range of visible light wavelengths. Preferably, the difference between the wavelength dependence of the optical distance through the layer for the two films is substantially uniform over the wavelength range of interest. The relative thickness of each of the films can be adjusted to modify the wavelength dependence of the composite of the films.

Alignment layers can optionally be used with the polarization rotator element to define the optical axis at surfaces of the polarization rotator element. This optical axis can be at an angle parallel to the surface of the alignment layer. In addition, in at least some instances, a tilt angle away from the surface of the alignment layer can be defined by the alignment layers. Alignment layers are particularly useful with liquid crystal materials to define the alignment of the director of the liquid crystal at the surfaces of the polarization rotator element. Alignment layers can be provided at opposing surfaces of the liquid crystal material (e.g., a polarization rotator element). One alternative includes using a single alignment layer and relying on the pitch and thickness of the polarization rotator element to determine the alignment at the opposing surface.

Alignment layers can be separately formed layers or can be part of one or more of the other optical components of the film. For example, the polarizer element can also act as an alignment layer. Optionally, the liquid crystal material can be crosslinked after alignment to maintain the alignment. Optionally, one or more of the alignment layers can be removed from the device after crosslinking or vitrifying the LC material.

A variety of methods are known for the preparation of alignment layers because alignment layers have been used in other components including in LC cells. Generally, one group of known techniques for making alignment layers involves mechanical or physical alignment, and a second group involves chemical and photoalignment techniques.

One commonly used mechanical method of making an alignment layer includes rubbing a polymer layer (e.g., poly(vinyl alcohol) or polyimide) in the desired alignment direction. Another physical method includes stretching or otherwise orienting a polymer film, such as a poly(vinyl alcohol) film, in the alignment direction. Any number of oriented polymer films exhibit alignment characteristics for LC materials, including polyolefins (such as polypropylenes), polyesters (such as polyethylene terephthalate and polyethylene naphthalate), and polystyrenes (such as atactic-, isotactic-, or syndiotactic-polystyrene). The polymer can be a homopolymer or a copolymer and can be a mixture of two or more polymers. The polymer film acting as an alignment layer can include one or more layers. Optionally, the oriented polymer film acting as an alignment layer can include a continuous phase and a dispersed phase. Yet another physical method includes obliquely sputtering a material, such as SiOₓ, TiO₂, MgF₂, ZnO₂, Au, and Al, onto a surface in the alignment direction. Another mechanical method involves the use of microgrooved surfaces, such as that described in U.S. Pat. Nos. 4,521,080, 5,946,064, and 6,153,272, all of which are incorporated herein by reference.

An alignment layer can also be formed photochemically. Photo-orientable polymers can be formed into alignment layers by irradiation of anisotropically absorbing molecules disposed in a medium or on a substrate with light (e.g., ultraviolet light) that is linearly polarized in the desired alignment direction (or in some instances perpendicular to the desire alignment direction), as described, for example, in U.S. Pat. Nos. 4,974,941, 5,032,009, and 5,958,293, all of which are incorporated by reference. Suitable photo-orientable polymers include polyimides, for example polyimides comprising substituted 1,4-benzenediamines.

Another class of photoalignment materials, which are typically polymers, can be used to form alignment layers. These polymers selectively react in the presence of polarized ultraviolet light along or perpendicular to the direction of the electric field vector of the polarized ultraviolet light, which once reacted, have been shown to align LC materials. Examples of these materials are described in U.S. Pat. Nos. 5,389,698, 5,602,661, and 5,838,407, all of which are incorporated herein by reference. Suitable photopolymerizable materials include polyvinyl cinnamate and other polymers such as those disclosed in U.S. Pat. Nos. 5,389,698, 5,602,661, and 5,838,407. Photoisomerizable compounds, such as azobenzene derivatives are also suitable for photoalignment, as described in U.S. Pat. Nos. 6,001,277 and 6,061,113, both of which are incorporated herein by reference.

Additionally, some lyotropic liquid crystal materials can also be used as alignment layers. Such materials, when shear-coated onto a substrate, strongly align thermotropic LC materials. Examples of suitable materials are described in, for example, U.S. patent application Ser. No. 09/708,752, incorporated herein by reference.

As an alternative to alignment layers, the liquid crystal material of the polarization rotator can be aligned using an electric or magnetic field. Yet another method of aligning the liquid crystal material is through shear or elongational flow fields, such as in a coating or extrusion process. The liquid crystal material may then be crosslinked or vitrified to maintain that alignment. Alternatively, coating the liquid crystal material on an aligned substrate, such as oriented polyesters like polyethylene terephthalate or polyethylene naphthalate, can also provide alignment.

A variety of different polarizer elements can be used. One type of polarizer element is a reflective polarizer element. Reflective polarizer elements can take a variety of forms. Suitable reflective polarizer elements include those which have two or more different materials of differing refractive index in alternating layers or as a dispersed phase within a continuous phase. Polymeric multilayer reflective polarizers are described in, for example, U.S. Pat. Nos. 5,882,774 and 5,965,247 and PCT Publication Nos. WO95/17303; WO95/17691; WO95/17692; WO95/17699; WO96/19347; and WO99/36262, all of which are incorporated herein by reference. One commercially available form of a multilayer reflective polarizer is marketed as Dual Brightness Enhanced Film (DBEF) by 3M, St. Paul, Minn. Inorganic multilayer reflective polarizers are described in, for example, H. A. Macleod, Thin-Film Optical Filters, 2nd Ed., Macmillan Publishing Co. (1986) and A. Thelan, Design of Optical Interference Filters, McGraw-Hill, Inc. (1989), both of which are incorporated herein by reference. Diffuse reflective polarizers include the continuous/disperse phase reflective polarizers described in U.S. Pat. No. 5,825,543, incorporated herein by reference, as well as the diffusely reflecting multilayer polarizers described in U.S. Pat. No. 5,867,316, incorporated herein by reference. Other reflective polarizers are described in U.S. Pat. Nos. 5,751,388 and 5,940,211, both of which are incorporated herein by reference.

Another example of a reflective polarizer element is formed using cholesteric liquid crystal material. The cholesteric liquid crystal polarizer element transmits right- or left-handed circularly polarized light at a wavelength corresponding to the optical length of the pitch of the cholesteric liquid crystal. The light that is not transmitted is reflected and is circularly polarized in the opposite helicity. Cholesteric liquid crystal reflective polarizers are described in, for example, U.S. Pat. No. 5,793,456, U.S. Pat. No. 5,506,704, U.S. Pat. No. 5,691,789, and European Patent Application Publication No. EP 940 705, all of which are incorporated herein by reference. As the LCD requires the input of linearly polarized light, cholesteric reflective polarizers are typically provided with a quarter wave retarder to convert the transmitted circularly polarized light into linearly polarized light. Suitable cholesteric reflective polarizers are marketed under the tradename TRANSMAX™ by Merck and Company, Incorporated and NIPOCS™ by Nitto Denko Corporation.

Another type of polarizer element is an absorbing polarizer element. These polarizer elements are typically made of a material that is oriented and absorbs light of a particular polarization. Examples of such polarizer elements include oriented polymer layers that are stained with a dichroic dye material, such as iodine or metal chelates. Examples of such constructions include a stretched poly(vinyl alcohol) layer that is stained with iodine. A discussion of suitable absorbing polarizers can be found in, for example, U.S. Pat. Nos. 4,166,871, 4,133,775, 4,591,512, and 6,096,375, which are all herein incorporated by reference.

Another type of absorbing polarizer element includes an oriented polymer, optionally made without additional dyes or stains, which includes segments, blocks, or grafts of polymeric material that selectively absorb light. One example of absorbing polarizer made without stains or dyes is an oriented copolymer that includes poly(vinyl alcohol) and polyvinylene blocks, where the polyvinylene blocks are formed by molecular dehydration of poly(vinyl alcohol). A discussion of polarizers made without dyes or stains can be found in, for example, U.S. Pat. Nos. 3,914,017 and 5,666,223, both of which are herein incorporated by reference.

Oriented polymer films of the above-described absorbing polarizer elements can also act as an alignment layer for the polarization rotator element, if desired. In one embodiment, an oriented poly(vinyl alcohol) absorbing polarizer element is provided over a reflective polarizer element (see, for example, U.S. Pat. No. 6,096,375). The oriented poly(vinyl alcohol) absorbing polarizer element optionally acts as an alignment layer for a polarization rotator element formed using liquid crystal material disposed on the absorbing polarizer element.

As indicated above, in place of the polarizer element (element 202 as illustrated in FIG. 3), another polarization-altering element can be used. Such polarization-altering elements include, for example, compensation films. These films alter the polarization of light to provide a different elliptical or circular polarization. This can provide a wider horizontal viewing angle, vertical viewing angle, or both for a display.

The film can have more than one polarizer element or other polarization-altering element. For example, a polarization rotator element can be disposed between two polarizer elements. Moreover, the film can include more than one polarization rotator element. In addition, other optical components can be included in the film, including, for example, microstructured prism films (such as described in, for example, U.S. Pat. Nos. 5,932,626 and 6,044,196, both of which are incorporated herein by reference), diffusion layers, scattering layers, and selective wavelength absorbing and transmitting layers. Other layers can be incorporated into the film which do not substantially alter the optical properties of the article including, for example, adhesive layers and substrates.

The optional substrate can simply be a layer which provides a base for deposition or formation of other layers. Alternatively or additionally, the substrate can be a structural support member during manufacture, use, or both. In some embodiments, the substrate performs no other function. In some instances the substrate can be a protective liner which is removed or discarded. Typically, unless the substrate is to be discarded, the substrates are transparent over the wavelength of operation of the polarization rotator and can be birefringent or non-birefringent. Examples of suitable substrates for these embodiments include cellulose triacetate (available from, for example, Fuji Photo Film Co. (Tokyo, Japan), Konica Corp. (Tokyo, Japan), and Eastman Kodak Co. (Rochester, N.Y.)), Sollx™ (available from General Electric Plastics (Pittsfield, Mass.)), and polypropylene or polyethylene films.

In at least some instances, the substrate can be characterized as optically isotropic. Alternatively, the substrate is a c-plate (e.g., the in-plane indices of refraction are the same, but different than the index of refraction in the thickness direction) and, more preferably, a negative c-plate, which serves to improve off-axis retardation effects introduced in a homeotropically aligned display cell. Examples of suitable substrates for these embodiments include, for example, those described in Japanese Patent Application Publication No. 2000/154,261A and U.S. Pat. No. 5,196,953, both of which are incorporated herein by reference.

In other embodiments, the substrate also performs one or more optical functions. For example, the substrate can be a polarizer element or compensation film or contain an absorbing material to provide color or reduce color in the film.

A variety of different articles can be constructed. These articles can be constructed in a number of different ways. In addition to the methods described herein, additional examples of methods of making the articles are described in the copending U.S. patent application Ser. No. ______, entitled “Methods of Making Polarization Rotators and Articles Containing the Polarization Rotators”, Docket No. 56233US002, filed on even date herewith and incorporated herein by reference. In particular, any of the individual elements of the article can be generated separately, sequentially, or simultaneously. For example, two or more of the elements (e.g., the polarizer element and an alignment layer) can be coextruded or can be simultaneously coated onto an optionally removable substrate. As another example, an element (e.g., the polarization rotator element) can be coated or otherwise disposed onto a previously formed layer (e.g., an alignment layer, the polarizer element, or a substrate). Alternatively, the individual elements can be formed separately and laminated together. A film can be formed using any combination of these methods. For example, a polarizer element and alignment layer can be coextruded; the polarization rotator element can be coated onto the alignment layer; and a second alignment layer and substrate laminated to the polarization rotator element to form the article.

The elements of the article can be integrated together to form the article by a variety of methods which will typically depend on factors such as, for example, the types of layers to be integrated together, the method of forming the individual elements, and the materials of the elements. It will be understood that several different methods can be used for a single film (e.g., the polarizer element and an alignment layer can be coextruded and then the polarization rotator element laminated to the alignment layer). Methods of integrating elements include, for example, coextrusion, coating, adhesive lamination, heat lamination, diffusion at elevated temperatures, reactive coupling between reactive groups on the two elements, and crosslinking. When an adhesive is used, the adhesive is preferably optically transparent over the wavelength range of interest, unless the adhesive is also used as an optical layer within the film.

The following are examples of film constructions. It will be understood that additional combinations can be formed by addition, removal, or substitution of elements of the illustrated films. In addition, it will be understood that the alignment layers illustrated in the Figures are optional. One of the other elements (e.g., the polarizer element) can serve as an alignment layer, alignment can be achieved using an electric or magnetic field, or one or more of the alignment layers can be removed after crosslinking or vitrification of the polarization element. As another alternative, a single alignment layer can be used with the alignment at the opposing surface being typically determined, at least in part, by the thickness and pitch of the material of the polarization rotator element.

FIG. 3 illustrates a configuration that can be used to describe a number of different embodiments. In one embodiment, a film 200 includes a polarizer element 202 (e.g., an absorbing polarizer element or a reflective polarizer element or both, optionally containing a quarter wave retarder), a polarization rotator element 204, a substrate 210, and two optional alignment layers 208, 206. The alignment layers can be formed using any of the techniques described above. One method of making such a film includes individually forming an alignment layer 206 on the polarizer element 202 and an alignment layer 208 on the substrate 210. Liquid crystal material for the polarization rotator element 204 can be disposed on one or both of the alignment layers 206, 208 and then the two separate constructs can be brought together and the polarization rotator element 204 formed, optionally, curing the liquid crystal material of the polarization rotator element to set the alignment of the polarization rotator element 204. The polarization rotator element is configured to rotate light exiting the polarizer element by a desired angle. This film can receive unpolarized light and transmit polarized light with the plane of polarization rotated by the desired angle from the polarization axis of the polarizer element 202. As an example, a reflective polarizer element oriented in the machine (0°) or transverse (90°) direction can be combined with a 45° polarization rotator element to form an article that can be used in the LCD of FIG. 1C while avoiding the waste associated with bias cutting the reflective polarizer at a 45° angle.

In another embodiment, the substrate 210 is a second polarizer element that has a polarization direction different than the polarization direction of polarizer element 202. The polarization rotator element is designed to rotate the polarization of light from the polarization axis of polarizer element 202 to align with the polarization axis of the second polarizer element 210, although, in some instances, the polarization rotator element may not fully align the light (e.g., the polarization rotator element may rotate the polarization by 30° for two polarizer elements with polarization axes that differ by 45°). As an example, polarizer element 202 can be a reflective polarizer element with a polarization axis of 0° and second polarizer element 210 is an absorbing polarizer element with a polarization axis of 90°. The polarization rotator element 204 is selected to rotate the polarization of light transmitted by the polarizer element 202 by 90° (or some other angle, if desired) to permit passage (only partial passage if the rotation angle is substantially different from 90°) of light through the second polarizer element 210.

In another embodiment, the substrate 210 is another polarization-altering element, such as a compensation film (for example, a compensation film as described in U.S. Pat. No. 6,064,457, incorporated herein by reference). In yet another embodiment, the polarizer element 202 is a reflective polarizer element and the alignment layer 206 is an oriented layer of poly(vinyl alcohol) stained with a dichroic dye(s) or optionally comprising polyvinylene blocks formed by molecular dehydration of poly(vinyl alcohol). This produces an absorbing polarizer element that can also act as an alignment layer for the polarization rotator element 204 in the direction of the orientation of the poly(vinyl alcohol).

FIG. 4 illustrates a film configuration that utilizes a reflective/absorbing polarizer element combination. The film 300 includes a reflective polarizer element 302, an absorbing polarizer element 303, a polarization rotator element 304, a substrate 310, and two optional alignment layers 306, 308. The layers can be formed and configured as discussed above. In another embodiment, a film 300 includes a polarizer element 302, a diffusing element 303, a polarization rotator element 304, a substrate 310, and two optional alignment layers 306, 308.

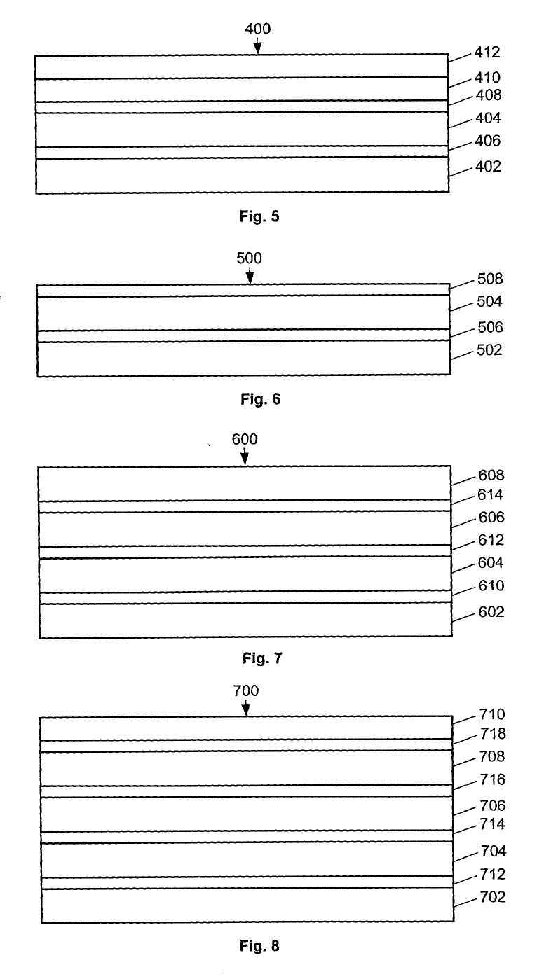

FIG. 5 illustrates a film configuration that incorporates another optical element, such as a second polarizer element or a compensation film. The film 400 includes a polarizer element 402 (e.g., a reflective polarizer element, an absorbing polarizer element, or a combination thereof), a polarization rotator element 404, a substrate 410, two optional alignment layers 406, 408, and another optical element 412 (e.g., a polarizer element or compensation film). Suitable compensation films include any commercial compensation film, such as, for example, the tilted o-plate compensation films of Rolic Technologies Ltd. (Allschwil, Switzerland), the hybrid aligned nematic films of Nippon Petrochemical Co. (Japan), and the splayed discotic films of Fuji Photo Film Co. (Tokyo, Japan). The polarization rotator element can additionally alter the ellipticity of polarized light exiting from the compensation films. The polarization rotator element can be designed to optimize operation with a particular compensation film by, for example, the choice of materials, indices of refraction, thickness of the polarization rotator element, and its location within film 400.

FIG. 6 illustrates a film configuration that does not require an additional substrate. The film 500 includes a polarizer element 502, a polarization rotator element 504, an alignment layer 506, and an optional second alignment layer 508 that can also provide sufficient structural support for manufacturing or use. For example, the second alignment layer 508 can be an oriented layer of poly(vinyl alcohol) or other polymer. Optionally, alignment layer 508 can be an absorbing polarizer element made from oriented poly(vinyl alcohol) and a dichroic component.

FIG. 7 illustrates a film that utilizes a cholesteric polarizer element. The film 600 includes a cholesteric polarizer element 602, a quarter wave retarder 604, a polarization rotator element 606, a polarizer element 608 (reflective or absorbing polarizer element or a combination thereof), and optional alignment layers 610, 612, 614. The cholesteric polarizer element 602 transmits circularly polarized light. The quarter wave plate 604 converts the circularly polarized light to linearly polarized light. The polarization rotator element 606 rotates the polarization of light from the quarter wave plate 604 into alignment (if desired) with the polarization axis of the polarizer element 608. As another alternative, the quarter-wave element can be aligned at 0° to the vertical axis of the film, in which case the resulting linearly polarized light is output at 45° with respect to the vertical axis.

FIG. 8 illustrates a film that incorporates two polarizer elements with different polarization axes and two polarization rotator elements to transmit light having a polarization in a different direction than the polarization axis of either polarizer element. The film 700 includes a first polarizer element 702, a first polarization rotator element 704, a second polarizer element 706, a second polarization rotator element 708, an optional substrate 710, and optional alignment layers 712, 714, 716, and 718. The first polarization rotator element 704 rotates the polarization of light transmitted by the first polarizer element 702 to be aligned (if desired) with the polarization axis of the second polarizer element 706. The second polarization rotator element 708 rotates light transmitted by the second polarizer element 706 to a desired polarization direction (e.g., 45° with respect to the vertical axis of the film 700 when viewed normal to the major face or plane of the device).

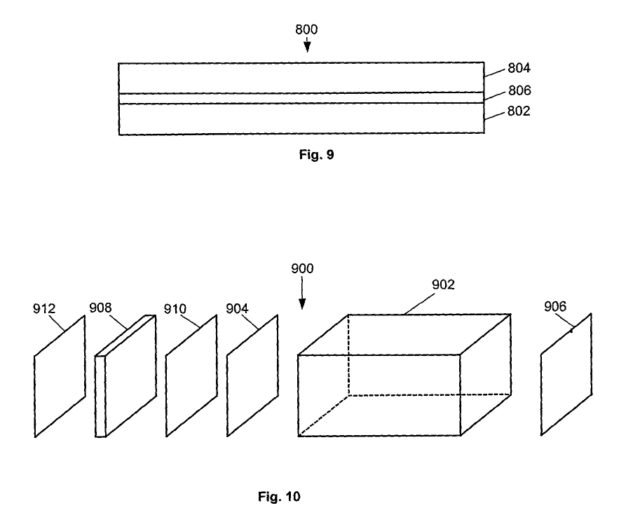

FIG. 9 illustrates a film configuration that does not require a second alignment layer. The film 800 includes a polarizer element 802, a polarization rotator element 804, and an alignment layer 806. The alignment at the other surface of the polarization rotator element can be provided by the ambient conditions (e.g., the atmosphere) or by the thickness of the layer.

In other embodiments, a polarizer element and a polarization rotator element are disposed on a light guide (e.g., a light guiding plate or fiber). Either the polarizer element or the polarization rotator element can be placed adjacent to the light guide. Any of the films described above can be used in these embodiments. Some light guides by their very nature preferentially extract one particular plane of polarization relative to the orthogonal plane of polarization.

In a specific embodiment of the present invention, a polarization rotator element rotates the plane of linearly polarized light by a angle such that it is colinear with the pass axis of the bottom polarizer of the LCD.

The films of the invention can be used in a variety of applications including in electronic displays, eyewear, window treatments, task lighting, electronic or optical switching and signal routing, telecommunications, and avionics. One particular application is in LCD's. FIG. 10 illustrates one embodiment of an LCD. It will be recognized that other LCD configurations are known and that the films can be used in those display configurations. The configuration of FIG. 10 is provided as an example to illustrate the use of the films.

An LCD 900 includes an LC cell 902, a polarizer 904, an analyzer 906, a backlight and light guide 908, a reflective polarizer 910, and a reflector 912. The films of the invention can be used in connection with any of the elements of the LCD including, for example, with the reflective polarizer 910, the polarizer 904, and the analyzer 906. For example, a film of the invention can be used as the reflective polarizer 910. One such film would include a reflective polarizer element and a polarization rotator element that rotates the polarization of light transmitted by the reflective polarizer element to a direction that can be transmitted by the polarizer 904. In this embodiment, the reflective polarizer element of the film and the polarizer 904 do not need to have polarization axes in the same direction. Thus, the reflective polarizer element of the film can have a polarization axis at 0° or 90° and the polarizer can have a polarization axis at 45°.

In another embodiment, the film can be used as the polarizer 904. The polarizer 904 in this embodiment includes a polarizer element and a polarization rotator element. In one configuration, the polarization rotator element rotates the polarization of light from the reflective polarizer 910 so that it can be transmitted by the polarizer element of the polarizer 904. In another configuration, the polarization rotator element rotates the polarization of light from the polarizer element so that it is parallel to or orthogonal to the liquid crystal director at the nearest surface of the LC cell 902.

In yet another embodiment, the film can be used as the analyzer 906. The analyzer 906 in this embodiment includes a polarizer element and a polarization rotator element. In one configuration, the polarization rotator element rotates the polarization of light transmitted from the LC cell 902.

The films can also be used in reflective and transflective displays. For example, the analyzer can include a polarizer element and a polarization rotator that rotates the polarization of light transmitted to the LC cell. The films can also be used in place of the LC cell polarizer or a reflective polarizer positioned after the LC cell polarizer in the same ways as used in the backlit displays.

In addition to these embodiments, other uses of the films can be envisioned. For example, the films can include a compensation film element and be used in place of commercial compensation films placed within the LCD.

The films can be configured to have multidomain or pixelated regions. For example, the alignment layers of the films can be configured so that there are regions with different alignment. Optionally, the top and bottom alignment layers can be arranged so that certain regions exhibit one degree of polarization rotation while other areas exhibit another degree of polarization rotation. For example, the films can be divided into pixels with a 90° polarization rotation within certain regions, while other regions exhibit substantially no polarization rotation. This can be achieved by selectively aligning the surface of the alignment layer. For example, only portions of the surface of the alignment layer can be rubbed or exposed to light (for photoaligned alignment layers). As another example, different portions of the surface of the alignment layer can be aligned in different directions by rubbing in different directions or exposing the portions of the alignment layer to light with different polarization angles. These configurations can be used to provide a display with off-axis image uniformity.

The following examples demonstrate the manufacture of articles of the invention. It is to be understood that these examples are merely illustrative and are in no way to be interpreted as limiting the scope of the invention.

### EXAMPLES

Unless otherwise indicated, any of the chemicals mentioned in the Examples can be obtained from Aldrich Chemical Co., Milwaukee, Wis.

### Example 1

An aqueous dispersion containing 9 wt. % Airvol 107 polyvinyl alcohol (Air Products, Allentown, Pa.), 1 wt. % WB54 (sulfonated polyester from 3M Co., St. Paul, Minn.), 3 wt. % N-methylpyrrolidone and 0.1 wt. % Triton X100 (Union Carbide, Danbury, Conn.) was coated onto a corona treated polyester cast web, using a shoe coater which delivered a wet coating thickness of 64 μm. The coating was dried at 105° C. for 1 minute. The PVA coated cast web was uniaxially oriented in a tenter oven at 150° C. to six times its original width. The final film had a thickness of 175 μm.

A thermoplastic liquid crystal material, Compound A,

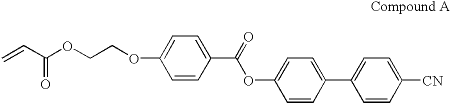

can be prepared according to European Patent Application Publication No. 834754, incorporated herein by reference. A 15 wt. % solution of Compound A was prepared in tetrahydrofuran (THF).

The solution was coated using a #18 Mayer wire coating rod (available from R. D. Specialties, Webster, N.Y.) onto the polyester:PVA substrate. The nominal wet thickness was about 45 μm. The substrate, once coated with liquid crystal material, was dried for 10 minutes at 110° C. to remove the THF solvent. This coated substrate was then laminated at about 120° C. to an identical liquid crystal coated substrate using a 3M Laminator Model 1147 (3M Company, St. Paul, Minn.). The orientation of the two coated uniaxially oriented substrates was 90° with respect to one another. This construction was then annealed at 110° C. for 20 minutes.

### Example 2

To 79 parts by weight of the Compound A used in Example 1 was added 12 parts by weight mesogenic diacrylate monomer (LC242, BASF AG, Ludwigshafen, Germany) and 2 parts by weight of a photoinitiator (Darocur 1173, Ciba Specialty Chemicals, Basel, Switzerland) to form a solution with 18 wt. % solids. Substrates were coated, dried, and laminated in accordance with Example 1. After lamination, this construction was irradiated with a 400 Watt mercury arc lamp for 3 minutes to crosslink the liquid crystal materials.

### Example 3

To 69 parts by weight of Compound A used in Example 1, 31 parts by weight of a low molecular weight liquid crystal (E7, EM Industries, Hawthorne, N.Y.) were added. The final THF solution comprised 20% solids. Substrates were coated, dried, and laminated in accordance with Example 1.

### Example 4

To 62 parts by weight of Compound A used in Example 1 was added 14 parts by weight mesogenic diacrylate monomer (LC242), 5 parts by weight of a photoinitiator (Darocur 1173), and 19 parts by weight of a low molecular weight liquid crystal (E7, EM Industries, Hawthorne, N.Y.). The final THF solution comprised 20% solids. Substrates were coated, dried, and laminated in accordance with Example 1.

### Example 5

A 20 wt. % reactive liquid crystal material (LC 242) was prepared in a solution of methylethylketone (MEK). A photoinitiator (Darocur 1173) was included in an amount corresponding to 3.5 wt. % of the reactive liquid crystal material and photoinitiator. The solution was coated using a #22 Mayer wire coating rod as described in Example 1. The coated substrate was baked for 2 minutes at 60° C. to remove solvent. The coated substrate was laminated in accordance with Example 1. Following lamination, the construction was irradiated in accordance with Example 2.

### Example 6

Example 6 illustrates one method of making a polarization rotator film with only a single alignment layer.

A 30 percent by weight solution of liquid crystal monomers in methylethylketone (MEK) was prepared. The liquid crystal monomer mixture comprised LC 242 and LC 756 (BASF AG, Ludwigshafen, Germany), and Irgacure 369 (Ciba Specialty Chemicals, Basel, Switzerland) in the ratio 96.4/0.1/3.5, respectively, by weight. The solution was agitated until the solids had completely dissolved in the MEK.

Using a 15 cm wide laboratory microgravure coater, the liquid crystal mixture was coated onto the polyester substrate described in Example 1 . The Gravure speed ratio was 0.66; i.e. the angular velocity of the Gravure roll was a factor of 0.66 times the line speed. The line speed was 4.57 meters per minute. The coating was dried at 80° C. and subsequently cured using a 600 Watt ultraviolet lamp (D-bulb, Fusion UV Systems, Gaithersburg, Md.) run at 100% power in an inert atmosphere.

The optical rotation of the LCP coating was evaluated using a RPA 2000 polarization analyzer (Instrument Systems, Ottawa, Ontario, Canada). Each sample was illuminated with polarized, collimated 633 nm light of known ellipticity (0.0°—i.e. linearly polarized) and azimuthal orientation of the polarization ellipse. The ellipticity and azimuthal orientation of the polarization ellipse of the light transmitted were determined to be 25.2° and 76.6°, respectively.

### Examples 7-9

Examples 7-9 were made in accordance with Example 6, with the exception that the ratio of the microgravure wheel to the line speed was altered. The results are summarized below.

| | GRAVURE | | AZIMUTHAL |
|---|---|---|---|
| EXAMPLE | SPEED RATIO | ELLIPTICITY [°] | ROTATION [°] |
| 7 | 1 | 18.2 | 84.60 |
| 8 | 1.33 | 20.2 | 82.80 |
| 9 | 2 | 7.0 | 89.20 |

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the instant specification.

What is claimed is:

1. A film, comprising:
a polarizer element having a polarization axis, wherein the polarizer element preferentially transmits light having a polarization that is parallel to the polarization axis; and
a separate polarization rotator element disposed in the film and configured and arranged to rotate the polarization of at least a portion of the light that is transmitted by the polarizer element by an angle of at least 5 degrees.

2. The film of claim 1, wherein the polarizer element is a first polarizer element and the film further comprises a second polarizer element having a polarization axis that differs from the polarization axis of the first polarizer element by at least 5 degrees and wherein the polarization rotator element is disposed between the first and second polarizer elements.

3. The film of claim 2, wherein the polarization rotator element is configured and arranged to rotate the polarization of at least a portion of the light transmitted by the first polarizer element to within five degrees of the polarization axis of the second polarizer element.

4. The film of claim 2, wherein the polarization rotator element is configured and arranged to rotate the polarization of at least a portion of the light transmitted by the first polarizer element to the polarization axis of the second polarizer element.

5. The film of claim 2, wherein the first polarizer element comprises a reflective polarizer and the second polarizer element comprises an absorbing polarizer.

6. The film of claim 1, further comprising an alignment layer disposed between the polarizer element and the polarization rotator element.

7. The film of claim 6, wherein the alignment layer comprises a polymeric material that has been photoaligned.

8. The film of claim 1, wherein the polarizer element comprises a surface that facilitates alignment of the polarization rotator element.

9. The film of claim 1, wherein the polarization rotator element comprises a liquid crystal material.

10. The film of claim 9, wherein the polarization rotator element further comprises a light absorbing material.

11. The film of claim 10, wherein the light absorbing material is aligned within the polarization rotator element to substantially absorb light having a first polarization and to substantially transmit light having a second polarization orthogonal to the first polarization.

12. The film of claim 9, wherein the polarization rotator element further comprises a light diffusing material.

13. The film of claim 1, wherein the polarizer element comprises a reflective polarizer.

14. The film of claim 1, wherein the polarizer element comprises an absorbing polarizer.

15. The film of claim 1, wherein the polarizer element comprises a reflective polarizer and an absorbing polarizer.

16. The film of claim 1, wherein the polarization rotator element rotates the polarization of the portion of the light that is transmitted by the polarizer element by an angle in the range of 40 to 50 degrees.

17. The film of claim 1, wherein the polarization rotator element rotates the polarization of the portion of the light that is transmitted by the polarizer element by an angle in the range of 85 to 95 degrees.

18. A film, comprising:
a polarizer element, wherein the polarizer element preferentially transmits a substantial portion of light having a first circular polarization; and
a polarization rotator element disposed in the film and configured and arranged to rotate the polarization of at least a portion of the light that is transmitted by the polarizer element to convert the polarization of the light from the first circular polarization to a first linear polarization.

19. The film of claim 18, wherein the polarizer element comprises chiral nematic liquid crystal material.

20. The film of claim 18, wherein the polarization rotator element is a first polarization rotator element and the film further comprises a second polarization rotator element, wherein the second polarization element is configured and arranged to rotate the polarization of at least a portion of light transmitted by the first polarization rotator element by at least five degrees.

21. A display, comprising:
(a) a liquid crystal cell that is configured and arranged to operate using polarized light;
(b) a light source; and
(c) a film disposed between the liquid crystal display cell and the light source, the film comprising
(i) a polarizer element having a polarization axis, wherein the polarizer element preferentially transmits light having a polarization that is parallel to the polarization axis; and
(ii) a separate polarization rotator element disposed in the film and configured and arranged to rotate the polarization of at least a portion of the light that is transmitted by the polarizer element by an angle of at least 5 degrees.

22. The display of claim 21, further comprising a polarizer disposed between the film and the liquid crystal cell, wherein the polarizer has a polarization axis that differs by at least five degrees from the polarization axis of the polarizer element of the film.

23. The display of claim 22, wherein the polarization rotator element is configured and arranged to rotate the polarization of at least a portion of the light transmitted by the polarizer element of the film to within five degrees of the polarization axis of the polarizer.

24. The film of claim 22, wherein the polarization rotator element is configured and arranged to rotate the polarization of at least a portion of the light transmitted by the polarizer element of the film to the polarization axis of the polarizer.

25. A method of polarizing light, the method comprising:
directing light at a polarizer element of a film, the polarizer element preferentially transmitting light having a first polarization; and
rotating, by at least five degrees, the polarization of at least a portion of the light transmitted by the polarizer element using a separate polarization rotator element of the film.

26. The method of claim 25, further comprising directing at least a portion of the light from the polarization rotator element to a second polarizer element of the film, wherein the second polarizer element has a polarization axis in a different direction than the polarizer element.
